(19) United States
(12) Patent Application Publication
(10) Pub. No.: US 2025/0128786 A1
(43) Pub. Date: Apr. 24, 2025

(54) ELECTRIC MOTORCYCLE

(71) Applicant: KAWASAKI MOTORS, LTD., Akashi-shi (JP)

(72) Inventors: Kohei KAWAKAMI, Akashi-shi (JP); Masato KOGIRIMA, Akashi-shi (JP)

(21) Appl. No.: 18/919,259

(22) Filed: Oct. 17, 2024

(30) Foreign Application Priority Data
Oct. 19, 2023 (JP) 2023-180232

(51) Int. Cl. B62M 7/12; B62J 1/08; B62J 25/00; B62J 43/16; B62J 43/28; B62K 21/12

(52) U.S. Cl. CPC B62M 7/12; B62J 1/08; B62J 25/00; B62J 43/16; B62J 43/28; B62K 21/12

(57) ABSTRACT

There is provided an electric motorcycle including: a vehicle body frame; a handle disposed above a front wheel; a seat on which an occupant sits. The vehicle body frame includes: a hollow main frame including a handle support portion, a seat support portion disposed behind the handle support portion, and a space extending rearward while being inclined downward from the handle support portion to the seat support portion and that accommodates a battery for a motor; a seat frame extending in an upper and lower direction, and connected to the seat support portion of the main frame at a lower portion; and a bridge frame extending in a front and rear direction, having a rear portion connected to the seat frame and a front portion connected to a portion of the main frame that is located behind the handle support portion.

### CROSS-REFERENCE TO RELATED APPLICATIONS

This application is based on and claims priority under 35 USC 119 from Japanese Patent Application No. 2023-180232 filed on Oct. 19, 2023, the contents of which are incorporated herein by reference.

### TECHNICAL FIELD

The present disclosure relates to an electric motorcycle.

### BACKGROUND ART

In related art, there have been proposed various electric motorcycles that travel by a driving force of a motor.

An electric motorcycle described in US2023-0062620A1 includes a vehicle body frame, a front wheel and a rear wheel rotatably supported by a vehicle body, a handle, a seat on which an occupant sits, a battery accommodated in the vehicle body frame, and a motor that is electrically connected to the battery and rotationally drives the rear wheel.

The vehicle body frame includes a hollow main frame that is a body portion of the vehicle body frame, and a seat frame that supports the seat.

The hollow main frame is a hollow tubular body extending downward toward a rear side of the vehicle. The main frame includes a handle support portion that supports the handle at a front portion thereof, and a seat support portion that supports the seat at a rear portion thereof. Further, the main frame has a space that extends rearward while being inclined downward from the handle support portion to the seat support portion, and that can accommodate a battery.

The seat frame extends in an upper and lower direction, supports the seat at an upper portion thereof, and is connected at a lower portion thereof to the seat support portion at the rear portion of the main frame.

In the above structure, the seat frame is erected independently in an upright or nearly upright state while being connected only to the seat support portion at the rear portion of the main frame. Therefore, when the electric motorcycle is traveling, a weight of the occupant acts downward from the upper portion of the seat frame, and a bending load acts on the seat frame mainly in a front and rear direction. Therefore, there is a concern about deformation and deterioration of the seat frame due to the bending load that acts thereon during traveling, and an improvement in bending rigidity of the seat frame is a problem.

### SUMMARY OF INVENTION

The present disclosure provides an electric motorcycle capable of improving bending rigidity of a seat frame.

According to an illustrative aspect of the present disclosure, an electric motorcycle includes: a vehicle body frame; a front wheel and a rear wheel; a handle disposed above the front wheel; a seat on which an occupant sits; a battery; and a motor electrically connected to the battery and configured to rotationally drive at least one of the front wheel and the rear wheel. The vehicle body frame includes: a hollow main frame including a handle support portion configured to support the handle, a seat support portion disposed behind the handle support portion and configured to support the seat, and a space extending rearward while being inclined downward from the handle support portion to the seat support portion and configured to accommodate the battery; a seat frame extending in an upper and lower direction, configured to support the seat at an upper portion, and connected to the seat support portion of the main frame at a lower portion; and a bridge frame extending in a front and rear direction, having a rear portion connected to the seat frame and a front portion connected to a portion of the main frame that is located behind the handle support portion.

According to the electric motorcycle of the present disclosure, the bending rigidity of the seat frame can be improved.

### BRIEF DESCRIPTION OF DRAWINGS

FIG. 1 is a right side view showing an overall configuration of an electric motorcycle according to an embodiment of the present disclosure;

FIG. 2 is a plan view of the electric motorcycle in FIG. 1;

FIG. 3 is a partially cutaway cross-sectional view of a main frame and a seat frame in FIG. 1 cut in an upper and lower direction;

FIG. 4 is an enlarged cross-sectional view showing an inside and a peripheral portion of the main frame in FIG. 3;

FIG. 5 is an enlarged perspective view showing a portion where a front portion of a bridge frame in FIG. 1 is joined to an upper surface of the main frame;

FIG. 6 is a perspective view showing a truss structure including the main frame, the seat frame, and the bridge frame in FIG. 1, and the inside and the peripheral portion of the main frame;

FIG. 7 is an enlarged perspective view of the main frame in FIG. 3 and a peripheral portion thereof as viewed from a lower right side with a cover removed;

FIG. 8 is an enlarged perspective view showing a structure in which a controller in FIG. 7 is held on a lower surface side of the main frame via a controller bracket;

FIG. 9 is a cross-sectional view taken along a line IX-IX in FIG. 4; and

FIG. 10 is a cross-sectional view taken along a line X-X in FIG. 4.

### DESCRIPTION OF EMBODIMENTS

Hereinafter, an electric motorcycle according to an embodiment of the present disclosure will be described in detail with reference to the drawings.

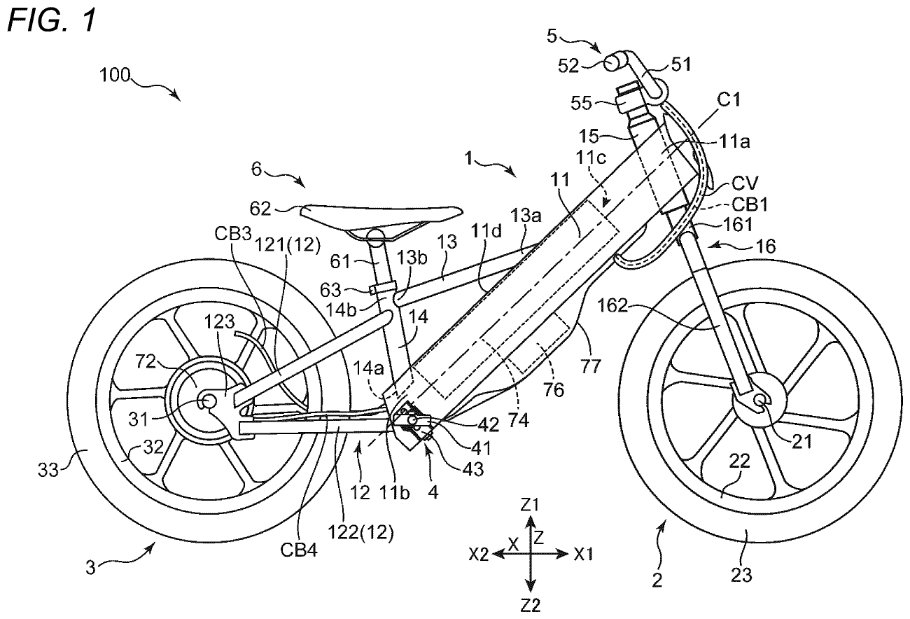

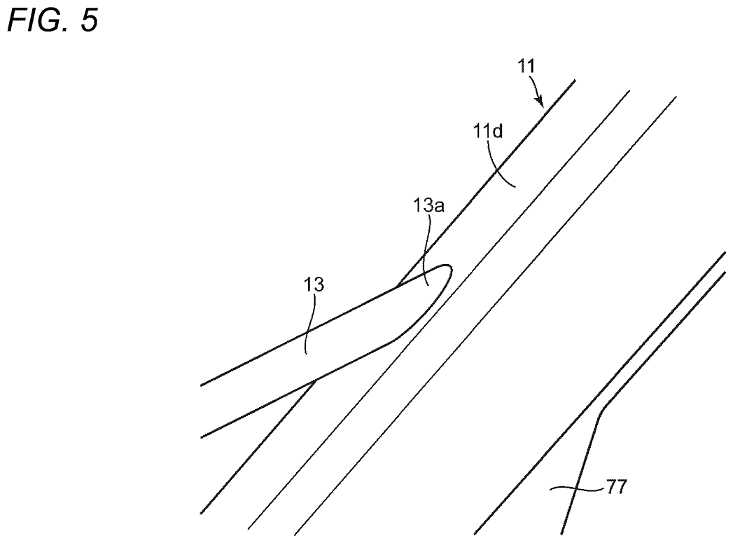

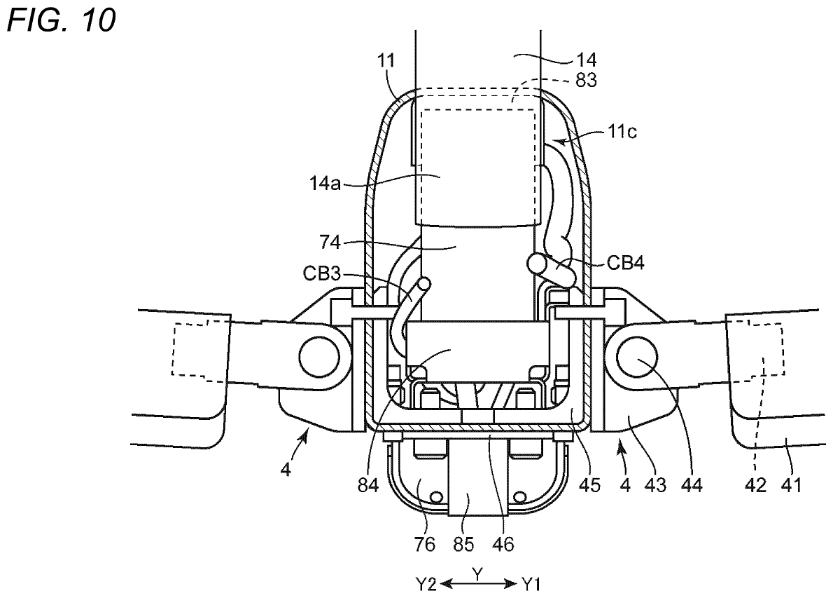

In FIGS. 1 to 10, a front and rear direction of an electric motorcycle 100 is represented by an arrow X (front side X1, rear side X2), a left and right direction thereof is represented by an arrow Y (right direction Y1, left direction Y2), and an upper and lower direction thereof is represented by an arrow Z (upper side Z1, lower side Z2).

As shown in FIGS. 1 to 6, the electric motorcycle 100 according to the present embodiment, a so-called electric motorcycle, includes a vehicle body frame 1, a front wheel 2 and a rear wheel 3, a handle 5, a seat 6 on which an occupant sits, a pair of steps 4, a battery 74, a motor 72, and a controller 76. The front wheel 2 and the rear wheel 3 are rotatably supported by the vehicle body frame 1. The handle 5 is disposed on the upper side Z1 of the front wheel 2. The pair of steps 4 are portions on which feet of the occupant are placed. The motor 72 is electrically connected to the battery 74 and rotationally drives the rear wheel 3. The controller 76 controls the motor 72.

The vehicle body frame 1 includes a hollow main frame 11 that is a body portion, a seat tube 14 (seat frame) that supports the seat 6, a bridge tube 13 (bridge frame), a rear tube 12 that supports the rear wheel 3, a head tube 15, and a front fork 16. The bridge tube 13 extends in a front and rear direction X and bridges the seat tube 14 and the main frame 11.

The vehicle body frame 1 is almost entirely made of a metal material that is lightweight and has sufficient rigidity to support a weight of the occupant such as aluminum or aluminum alloy, or a resin material.

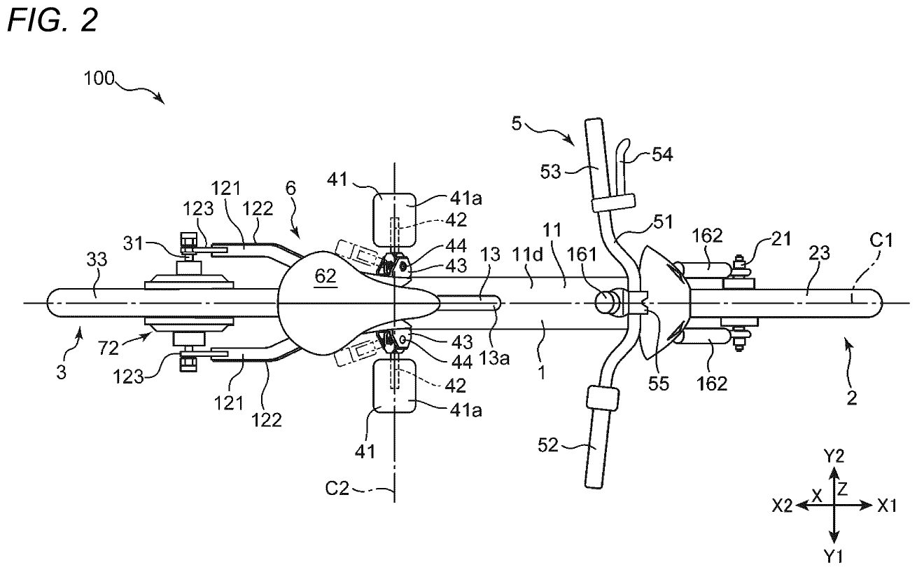

The hollow main frame 11 is a hollow member extending in a downward direction toward the vehicle rear side X2. The main frame 11 includes a handle support portion 11a for supporting the handle 5 at a front portion thereof, and a seat support portion 11b for supporting the seat 6 at a rear portion thereof. Further, the main frame 11 has a space 11c that extends toward the rear side X2 while being inclined toward the lower side Z2 from the handle support portion 11a to the seat support portion 11b. The space 11c extends along a central axis C1 in FIGS. 1 and 2 and can accommodate a long rectangular parallelepiped battery 74. The main frame 11 has a flat upper surface 11d. An opening 11e through which the seat tube 14 penetrates is formed in a range of the seat support portion 11b constituting the rear portion of the main frame 11 in the upper surface 11d.

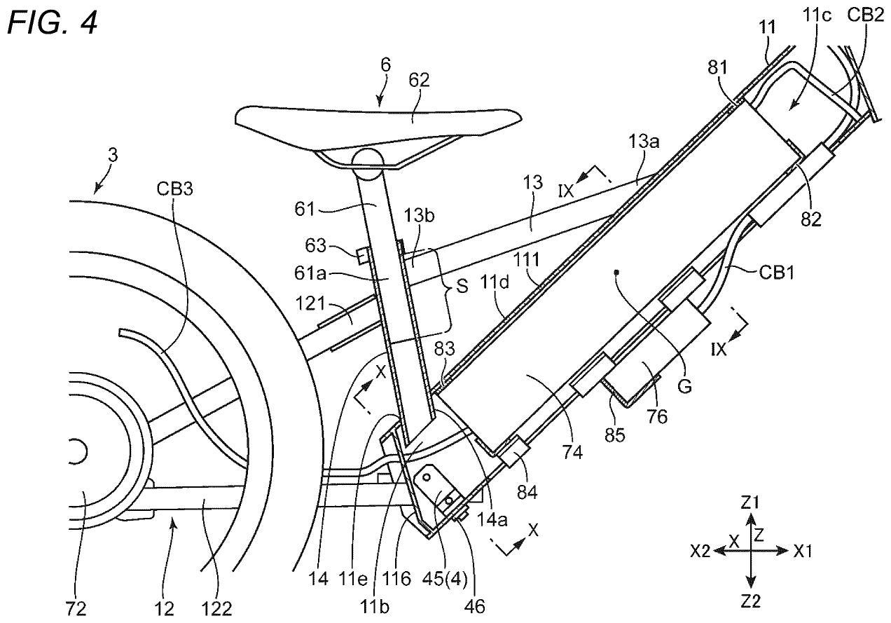

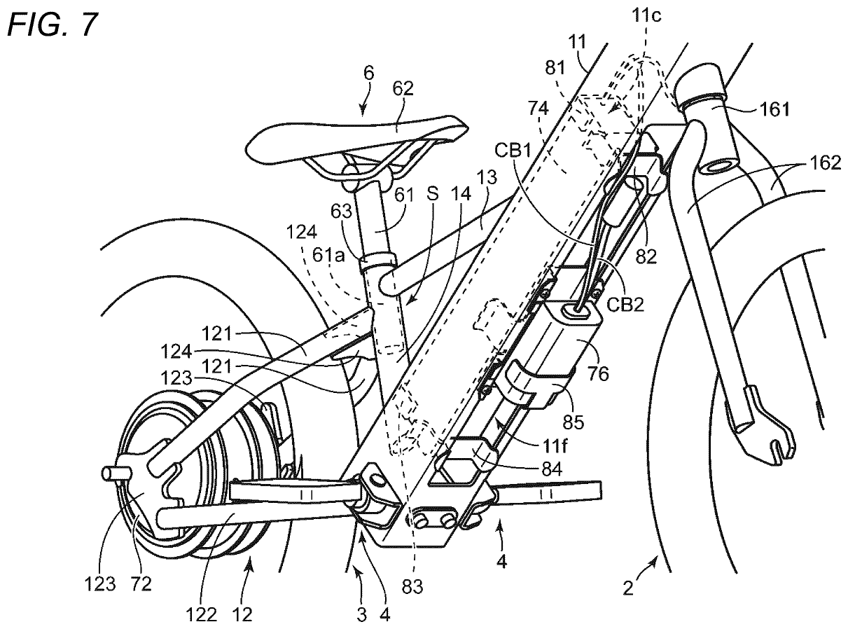

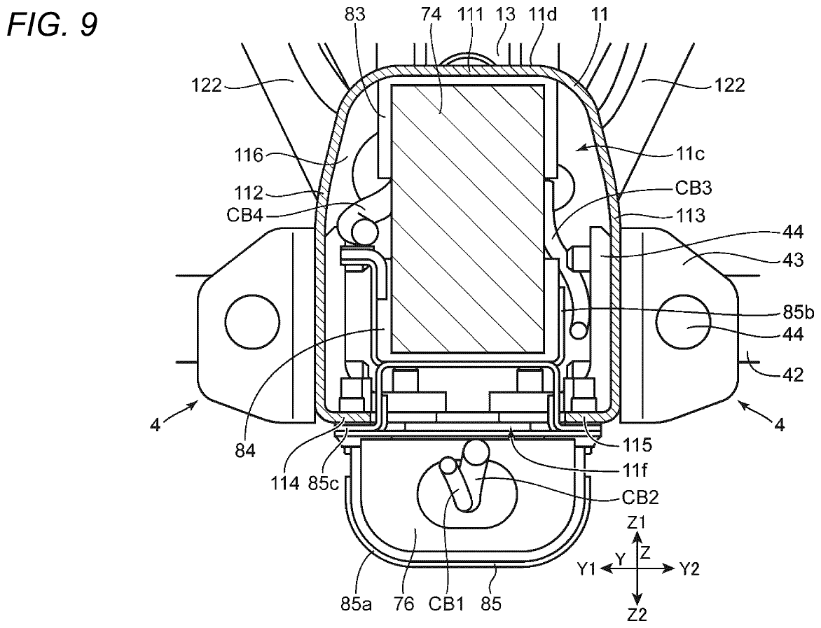

Specifically, the main frame 11 is a long hollow body having a substantially U-shaped cross section in which an opening 11f is formed in a lower surface shown in FIGS. 7 to 9. As shown in FIG. 9, the main frame 11 includes a top plate 111, a pair of left and right side walls 112 and 113, and a pair of left and right lower flanges 114 and 115. The top plate 111 is a flat plate-shaped portion having the flat upper surface 11d. The pair of left and right side walls 112 and 113 extend downward Z2 from edges on both left and right sides (both sides in a left and right direction Y) of the top plate 111. The pair of left and right lower flanges 114 and 115 are bent respectively from lower end portions of the pair of side walls 112 and 113 toward a central side in the left and right direction Y of the main frame 11. The top plate 111, the pair of side walls 112 and 113, and the pair of lower flanges 114 and 115 form the substantially rectangular parallelepiped space 11c extending along the central axis C1 of the main frame 11 (see FIGS. 1 and 2). As shown in FIGS. 4, 6, and 9, a rear end portion of the main frame 11 is closed by a rear wall 116. A front wall, a headlight, and the like are disposed at a front end portion of the main frame 11.

The opening 11f communicating with the space 11c is formed between the pair of lower flanges 114 and 115. The battery 74 can be accommodated in the space 11c of the main frame 11 through the opening 11f.

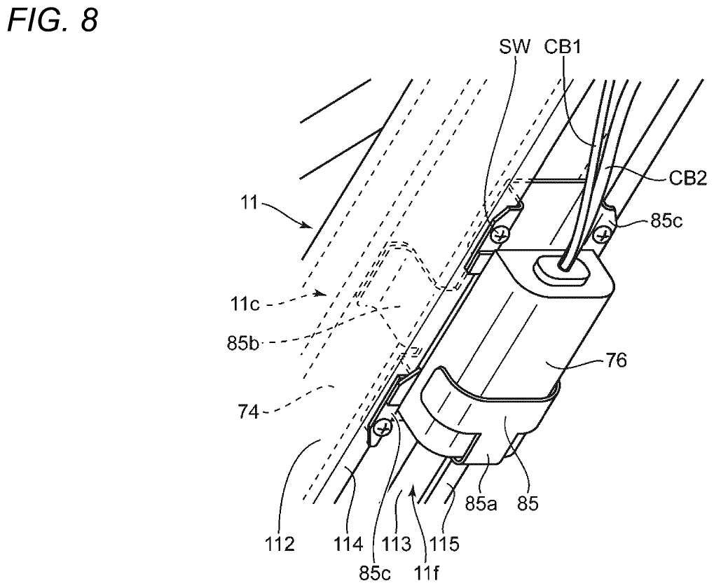

In a normal state of the electric motorcycle 100, the opening 11f is closed by a cover 77 as shown in FIGS. 1, 3, and 6. The cover 77 is detachably fixed to the pair of lower flanges 114 and 115 (see FIGS. 8 and 9) by screws or the like in a state of covering the controller 76.

As described above, the main frame 11 is formed to have the U-shaped cross section in which the upper surface 11d is a flat surface, and thus it is easy to accommodate the rectangular parallelepiped battery 74. The main frame 11 is a member having the U-shaped cross section that is larger than other frames (the seat tube 14, a seat stay 121, and the like) constituting the vehicle body frame 1, and thus is larger and more rigid than other frames. Therefore, deformation of the bridge tube 13 and the seat tube 14 coupled to the main frame 11 can be prevented.

As shown in FIGS. 1 to 4, and 6, the seat tube 14 is a tubular body extending in an upper and lower direction Z. The seat tube 14 supports the seat 6 (specifically, a seat post 61 to be described below) at an upper portion thereof, and is connected to the seat support portion 11b of the main frame 11 at a lower end portion 14a (lower portion) thereof.

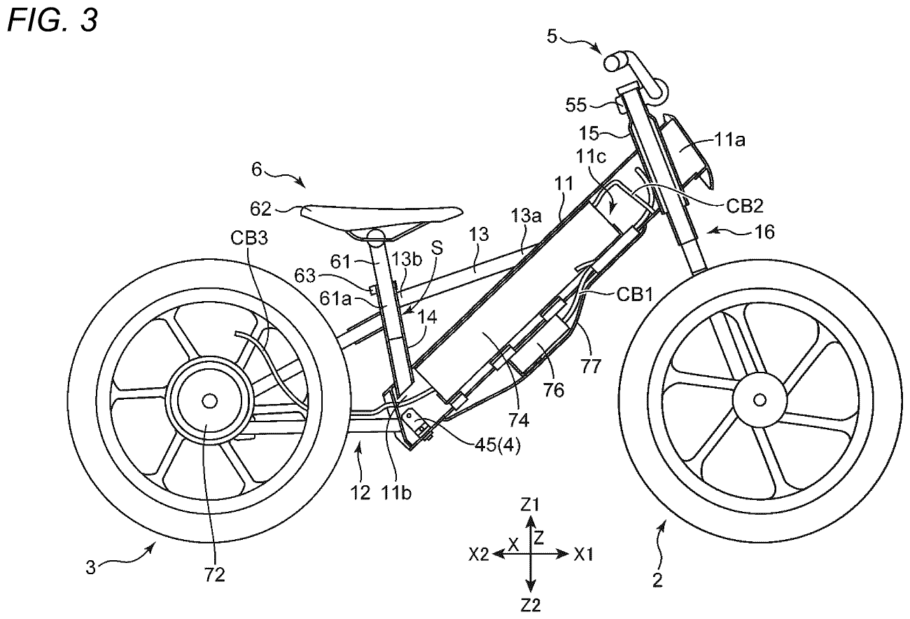

The seat tube 14 communicates with the space 11c through the opening 11e formed in the upper surface 11d of the main frame 11. Specifically, as shown in FIGS. 3, 4, and 6, the lower end portion 14a of the seat tube 14 passes through the opening 11e of the main frame 11, penetrates the upper surface 11d, and protrudes into the space 11c of the main frame 11. A peripheral edge portion of the opening 11e of the main frame 11 is welded to an outer peripheral surface of the seat tube 14 at the lower end portion 14a over the entire periphery.

The seat tube 14 communicates with the space 11c through the opening 11e formed in the upper surface 11d of the main frame 11. Therefore, the seat post 61 can descend through the seat tube to a position where the lower end portion 61a of the seat post 61 is inserted into the space 11c of the main frame 11, and thus a large amount of movement of the seat post 61 in the upper-lower direction can be ensured.

An upper end 14b of the seat tube 14 is located on the lower side Z2 of an upper end of the rear wheel 3.

As shown in FIGS. 1 to 6, the bridge tube 13 (bridge frame) is a tubular body extending in the front and rear direction X. A rear end portion 13b (rear portion) of the bridge tube 13 is connected to the seat tube 14. The rear end portion 13b is welded over the entire periphery of the rear end portion 13b while abutting against a front surface of the seat tube 14 on an outer peripheral side.

A front end portion 13a (front portion) of the bridge tube 13 is connected to a portion of the main frame 11 on the rear side X2 of the handle support portion 11a. A connection position between the bridge tube 13 and the main frame 11 is located on the upper side Z1 of the upper end of the rear wheel 3. The front end portion 13a of the bridge tube 13 is connected to the main frame 11. The front end portion 13a is welded over the entire periphery while abutting against the flat upper surface 11d of the main frame 11.

In the above configuration, since the vehicle body frame 1 includes the bridge tube 13, bending rigidity of the seat tube 14 can be improved. Specifically, a lower portion of the seat tube 14 that supports the seat 6 is connected to the seat support portion 11b at the rear portion of the main frame 11 and extends in the upper and lower direction Z, and is connected to the main frame 11 via the bridge tube 13 extending in the front and rear direction X. In this structure, the main frame 11, the seat tube 14, and the bridge tube 13 are connected to one another, thereby forming a triangle as viewed from the left and right direction Y of the electric motorcycle 100 and constituting a so-called truss structure. In this structure, the seat tube 14 is reinforced by a top frame, and bending rigidity of the electric motorcycle 100 in the front and rear direction X can be particularly improved.

In the above configuration, since the bridge tube 13 is connected to a portion of the main frame 11 on the rear side X2 of the handle support portion 11a, it is easy to prevent the bridge tube 13 from becoming elongated and reduce a weight thereof. The bridge tube 13 can reinforce the main frame 11 by being connected to the main frame 11 that accommodates the battery 74. Accordingly, deformation of the space in which the battery 74 is accommodated can be prevented even when the electric motorcycle 100 falls over or collides. As a result, damage to the battery 74 and deterioration in workability of attaching and detaching the battery 74 can be prevented.

As described above, the front end portion 13a of the bridge tube 13 abuts against the upper surface 11d of the main frame 11, but is not inserted into the space 11c of the main frame 11. Therefore, the space 11c of the main frame 11 is formed to extend in the upper and lower direction Z with respect to a connection portion with the front end portion 13a of the bridge tube 13. In this configuration, the front end portion 13a of the bridge tube 13 is connected to the upper surface 11d of the main frame 11 and thus does not enter the space 11c of the main frame 11. Therefore, interference between the space 11c of the main frame 11 and the bridge tube 13 can be prevented, and the space 11c can be made larger. As a result, a large battery 74 can be used.

As described above, a joining surface between the front end portion 13a of the bridge tube 13 and the upper surface 11d of the main frame 11 is formed into a flat surface by the flat upper surface 11d of the main frame 11. Therefore, when welding a front end of the bridge tube 13, the bridge tube 13 abuts against the main frame 11, and the bridge tube 13 can be prevented from falling from the main frame 11, so that connection work can be easily performed. That is, welding becomes easy.

Since the joining surface between the bridge tube 13 and the main frame 11 is formed as the flat surface, a gap is less likely to occur when the bridge tube 13 abuts the main frame 11 as compared with a case where the joining surface is formed as a curved surface.

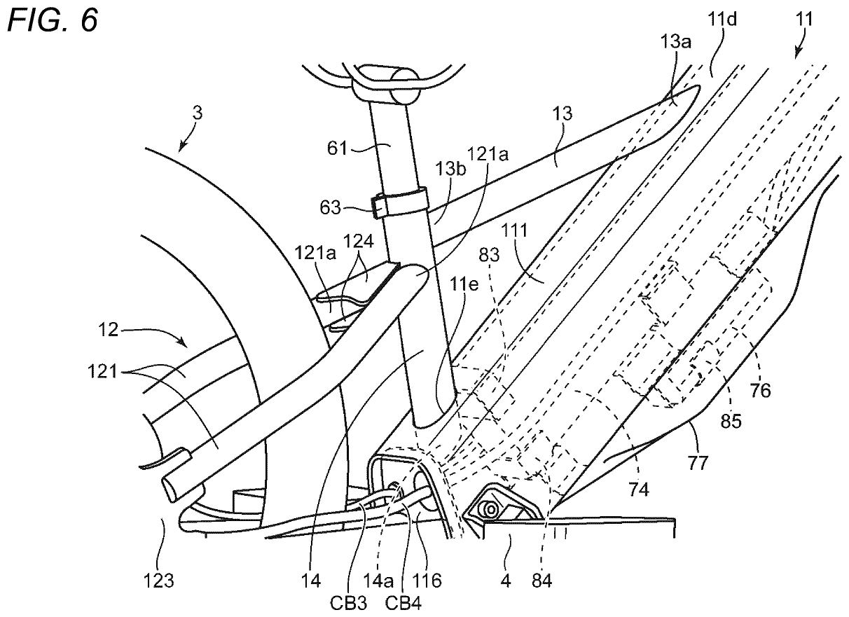

As shown in FIGS. 1 and 4, the rear tube 12 has a configuration that rotatably supports the rear wheel 3 of the vehicle body frame 1. Specifically, the rear tube 12 includes a pair of left and right rear wheel support portions 123, a pair of left and right seat stays 121, and a pair of left and right lower stays 122. The pair of left and right rear wheel support portions 123 rotatably support the rear wheel 3. The pair of left and right seat stays 121 extend in the front and rear direction X between the pair of rear wheel support portions 123 and the seat tube 14. As shown in FIGS. 4 and 6, the pair of left and right lower stays 122 extend in the front and rear direction X between the pair of rear wheel support portions 123 and the rear wall 116 of the main frame 11 below the pair of seat stays 121.

As shown in FIGS. 6 and 7, front end portions 121a of the pair of left and right seat stays 121 are connected to the outer peripheral surface of the seat tube 14 by welding or the like. A pair of upper and lower brackets 124 are connected to the pair of seat stays 121 and the seat tube 14 by welding or the like with the front end portions 121a of the pair of seat stays 121 interposed therebetween. The pair of upper and lower brackets 124 can prevent not only deformation of the seat tube 14 but also deformation of the pair of seat stays 121.

As shown in FIGS. 1 to 4, 6, and 7, the seat 6 includes the seat post 61 extending in the upper and lower direction Z, a saddle 62 fixed to an upper end portion of the seat post 61 to support buttocks of the occupant, and a clamp 63.

As shown in FIG. 4, at least the lower end portion 61a of the seat post 61 is inserted into an upper portion of the seat tube 14. The seat post 61 is fixed by the clamp 63 tightening the upper portion of the seat tube 14 from the outside at a position where the saddle 62 is at a height that makes it easy for the occupant to sit. A slit is preferably formed in the upper portion of the seat tube 14. Presence of the slit facilitates reducing an opening diameter of the seat tube 14 when tightening the seat tube 14 from the outside by the clamp 63.

The seat post 61 is inserted into the seat tube 14 as described above, thereby forming an overlapping portion S (see FIGS. 3, 4, and 7) of the seat post 61 and the seat tube 14. The rear end portion 13b of the bridge tube 13 is connected to the seat tube 14 in a range of the overlapping portion S on the outer peripheral surface of the seat tube 14. A front end of the seat stay 121 is connected to the seat tube 14 in the range of the overlapping portion S. In the above configuration, since the bridge tube 13 is connected to the seat tube 14 in the range of the overlapping portion S, a load from the seat post 61 can be easily transmitted to the bridge tube 13, and deformation of the seat tube 14 can be prevented.

On a rear side of the seat tube 14, the seat stay 121 is connected to the seat tube 14 in the range of the overlapping portion S. Accordingly, the load from the seat post 61 can be easily transmitted to both the bridge tube 13 and the seat tube 14, and the deformation of the seat tube 14 can be further prevented.

A connection position between the bridge tube 13 and the seat tube 14 (that is, a position of a rear end of the bridge tube 13) is located on the upper side Z1 of a connection position between the seat stay 121 and the seat tube 14 (that is, a position of the front end of the seat stay 121). In this configuration, the seat tube 14 is connected to the bridge tube 13 at a portion close to an upper end portion of the seat tube 14. As compared with a case where the bridge tube 13 is connected at a portion away from the upper end portion of the seat tube 14, the upper end portion of the seat tube 14 can be easily prevented from being deformed forward.

The bridge tube 13 is inclined toward the upper side Z1 as advancing to the front side X1. The bridge tube 13 extends substantially parallel to the seat stay 121. In addition, the bridge tube 13 is connected to a substantially intermediate position of the main frame 11 in a longitudinal direction (direction along the central axis C1).

As shown in FIGS. 1 and 3, the head tube 15 is a substantially cylindrical pipe member extending in the upper and lower direction at the handle support portion 11a in a front portion of the main frame 11. An intermediate portion of the head tube 15 in the upper and lower direction Z is inserted inside the main frame 11. The intermediate portion of the head tube 15 is joined to the handle support portion 11a of the main frame 11 by welding or the like.

As shown in FIGS. 1 and 2, the front fork 16 includes a steering column 161 and a pair of left and right leg portions 162. The steering column 161 is a substantially cylindrical pipe member extending in the upper and lower direction Z. An intermediate portion of the steering column 161 is fixed to the head tube 15 while being inserted inside the head tube 15. The steering column 161 is inserted inside the head tube 15 coaxially with the head tube 15. The steering column 161 is rotatable about a central axis of the head tube 15. The pair of leg portions 162 are pipe members that extend downward while branching left and right from a lower end portion of the steering column 161. The front wheel 2 is fixed to the front fork 16 by fastening both end portions of an axle 21 thereof to lower end portions of the leg portions 162.

The battery 74 has a substantially rectangular parallelepiped shape and is accommodated in the space 11c of the main frame 11. The battery 74 is inserted into the space 11c from the lower opening 11f of the main frame 11 shown in FIGS. 7 to 9. As shown in FIGS. 6 to 10, the battery 74 is fixed to an inner peripheral surface of the space 11c via four brackets 81 to 84 by screwing or the like.

The four brackets 81 to 84 fix a front end portion of the battery 74 at two upper and lower positions and a rear end portion at two upper and lower positions. Specifically, the four brackets 81 to 84 are referred to as a battery front upper bracket 81, a battery front lower bracket 82, a battery rear upper bracket 83, and a battery rear lower bracket 84, respectively.

The battery front upper bracket 81 and the battery rear upper bracket 83 are inverted U-shaped members each having a pair of arm portions extending downward. The battery front upper bracket 81 and the battery rear upper bracket 83 are fixed to the inner peripheral surface of the space 11c of the main frame 11 by screwing or the like, and fix while clamping a front upper end portion and a rear upper end portion of the battery 74.

The battery front lower bracket 82 includes a portion that comes into contact with a front surface lower portion, both left and right side surface lower portions, and a lower surface front portion of the battery 74 in order to support a front lower portion of the battery 74. The battery front lower bracket 82 is fixed to both the left and right side walls 112 and 113 and both the left and right lower flanges 114 and 115 of the main frame 11 by screwing or the like while supporting the front lower portion of the battery 74.

The battery rear lower bracket 84 includes a portion that comes into contact with a rear surface lower portion, both left and right side surface lower portions, and a lower surface rear portion of the battery 74 in order to support a rear lower portion of the battery 74. The battery rear lower bracket 84 is fixed to both the left and right side walls 112 and 113 and both the left and right lower flanges 114 and 115 of the main frame 11 by screwing or the like while supporting the rear lower portion of the battery 74.

A gravity center position G of the battery 74 (see FIG. 4) is located in the main frame 11 on the lower side Z2 of the connection portion with the front end portion 13a of the bridge tube 13. Therefore, the battery 74, which is a heavy object among components constituting the electric motorcycle 100, is disposed at a low position within the main frame 11, thereby improving traveling stability of the electric motorcycle 100.

The opening 11f (see FIGS. 7 to 9) for inserting the battery 74 into the main frame 11 is formed on a lower surface side of the main frame 11 in a surface other than the upper surface 11d where the connection position between the main frame 11 and the bridge tube 13 is located. Accordingly, when attaching the battery 74 to or detaching the battery 74 from the main frame 11 through the opening 11f on the lower surface side of the main frame 11, the battery 74 does not come into contact with the bridge tube 13. As a result, it is easy to attach and detach the battery 74.

An opening for inserting the battery 74 into the main frame 11 may be formed in each of left and right side surfaces of the main frame 11 since the above effect can be achieved in any surface other than the upper surface 11d of the main frame 11.

A fixed position of the battery 74 in the space 11c is set to the front side X1 of the lower end portion 14a of the seat tube 14. Accordingly, even when the seat 6 is lowered and a lower end of the seat post 61 protrudes into the space 11c of the main frame 11, interference between the battery 74 and the lower end of the seat post 61 can be prevented.

As shown in FIGS. 1, 3, 4, and 6 to 9, the controller 76 is attached to the pair of lower flanges 114 and 115 of the main frame 11 via a controller bracket 85. Accordingly, the controller 76 is disposed in a hanging state below the main frame 11. The controller 76 is covered with the cover 77 and is protected from foreign matter outside the cover 77.

As shown in FIGS. 8 and 9, the controller bracket 85 includes a controller holding portion 85a, a battery holding portion 85b, and a pair of left and right coupling portions 85c. The controller holding portion 85a holds the controller 76. The battery holding portion 85b extends into the space 11 and holds the battery 74. The pair of left and right coupling portions 85c are detachably fixed to the pair of lower flanges 114 and 115 of the main frame 11 by screws SW or the like. The controller bracket 85 is integrally molded from a metal or resin material.

In the controller bracket 85, the pair of coupling portions 85c are fixed to the pair of lower flanges 114 and 115 on both left and right sides of the lower opening 11f of the main frame 11. Accordingly, the controller bracket 85 couples the pair of lower flanges 114 and 115 across the opening 11f, thereby contributing to reinforcement of the main frame 11 having the substantially U-shaped cross section with the opening 11f on a lower side. In particular, this contributes to reinforcement of a peripheral portion of the opening 11f of the main frame 11.

The controller 76 is disposed on the lower side Z2 the connection position between the front end portion 13a of the bridge tube 13 and the main frame 11. In addition, the controller 76 is disposed on the upper side Z1 of a connection position between the lower end portion 14a of the seat tube 14 and the main frame 11 (that is, the seat support portion 11b of the main frame 11).

As shown in FIGS. 1, 2, 6, and 7, the pair of steps 4 respectively have placing surfaces 41a on which the feet of the occupant can be placed. The pair of steps 4 are fixed to the rear portion of the main frame 11 (in the vicinity of the seat support portion 11b to which the seat tube 14 is connected) and extend in the left and right direction Y. A comfortable driving posture can be maintained by placing the feet of the occupant on the placing surfaces 41a of the steps 4 during traveling.

Each of the pair of steps 4 includes a step body portion 41, a support shaft 42, a side bracket 43, and a pivot shaft 44. The step body portion 41 is a flat plate-shaped portion having the placing surface 41a. The support shaft 42 has a central axis C2 (see FIG. 2) extending in the left and right direction Y, and supports the step body portion 41 to be pivotable in the front and rear direction X. The side bracket 43 is fixed to the side wall of the main frame 11. Both end portions of the pivot shaft 44 are rotatably supported by the side bracket 43. The pivot shaft 44 supports the support shaft 42 to be pivotable between a normal position where the support shaft 42 extends in the left and right direction Y and a storage position where the support shaft 42 is folded toward the upper surface 11d of the main frame 11.

When the electric motorcycle 100 travels due to being driven by the motor 72, the support shaft 42 is in the normal position where the support shaft 42 extends in the left and right direction Y. Accordingly, the occupant can place the feet on the placing surfaces 41a of the step body portions 41, and can have a comfortable riding posture. By placing the support shaft 42 in the storage position where the support shaft 42 is folded toward the upper surface 11d of the main frame 11, the occupant can drive the electric motorcycle 100 with the motor 72 stopped while kicking the ground.

As shown in FIGS. 3, 4, and 10, an inner bracket 45 and a lower bracket 46 for reinforcing the main frame 11 are fixed at positions where the side brackets 43 of the pair of steps 4 are attached to the rear portion of the main frame 11. The inner bracket 45 comes into contact with the inner peripheral surface of the space 11c of the main frame 11. The lower bracket 46 comes into contact with a lower surface of the main frame 11 on an outer peripheral side. The inner bracket 45 and the lower bracket 46 are fixed to the main frame 11 by screwing or the like.

Other configurations of the electric motorcycle 100 are as follows.

As shown in FIGS. 1 to 3, the front wheel 2 includes an axle 21, a wheel body 22, and a tire 23. The wheel body 22 is attached to the axle 21 via a bearing. The tire 23 is a rubber component and is attached to an outer peripheral portion of the wheel body 22. Similarly, the rear wheel 3 includes an axle 31, a wheel body 32, and a tire 33. The wheel body 32 is attached to the axle 31 via a bearing. The tire 33 is a rubber component and is attached to an outer peripheral portion of the wheel body 32.

The motor 72 is coupled to the rear wheel 3. The motor 72 is an electric motor that rotates by receiving electric power supplied from the battery 74 as described above. The motor 72 mounted on the electric motorcycle 100 according to the present embodiment is a so-called in-wheel motor, and is coaxially attached to a hub that is a central portion of the wheel body 32 of the rear wheel 3 so as to directly rotate the rear wheel 3. The motor 72 includes a stator that is non-rotatable with respect to the axle 31, and a rotor that rotates with respect to the stator when energized. Rotation of the rotor is transmitted to the wheel body 32 via an output shaft coaxial with the wheel body 32, thereby rotationally driving the rear wheel 3. In the electric motorcycle 100 according to the present embodiment, the in-wheel motor is used as the motor 72 as described above, thereby simplifying a drive system and reducing a weight thereof.

The motor 72 may rotationally drive at least one of the front wheel 2 and the rear wheel 3. The motor 72 in FIG. 1 rotationally drives the rear wheel 3, and may rotationally drive the front wheel 2. The motor may rotationally drive both the front wheel 2 and the rear wheel 3.

The handle 5 includes a handlebar 51, an accelerator grip 52, a brake side grip 53, a brake lever 54, and other driving mode changeover switches. The handlebar 51 is a bar extending in the left and right direction, and is fixed to an upper end portion of the steering column 161 of the front fork 16 via a stem portion 55. When the handlebar 51 is steered in the front and rear direction, the front fork 16 rotates about an axis to change a direction of the front wheel 2, thereby changing a traveling direction of the electric motorcycle 100. The accelerator grip 52 is a grip that is twisted and operated by the occupant when the electric motorcycle 100 is electrically driven, and is attached to cover a right side portion of the handlebar 51. The accelerator grip 52 is attached to the handlebar 51 while being rotatable about an axis extending in the left and right direction. The brake side grip 53 is a grip that the occupant grips with a left hand, and is attached to cover a left side portion of the handlebar 51. The brake lever 54 is a lever that is gripped and operated by the occupant when decelerating the electric motorcycle 100. The brake lever 54 is attached to the handlebar 51 while extending in the left and right direction in front of the brake side grip 53.

The accelerator grip 52 is electrically connected to the controller 76 via a cable CB1 (see FIGS. 1, 3, 4, and 7 to 9). The cable CB1 is guided from the handle 5 to the inside of the cover 77 through a cable cover CV. The controller 76 is electrically connected to the motor 72 via a cable CB2. When the occupant performs an operation of twisting the accelerator grip 52, a signal indicating an operation amount of the twisting operation or the like is input to the controller 76. The controller 76 controls power supply from the battery 74 to the motor 72 through a cable CB3 such that the motor 72 is rotationally driven at a desired rotation speed based on the input operation signal. The brake lever 54 is mechanically connected to a brake attached to the rear tube 12 via a cable CB4. When the occupant performs an operation of gripping the brake lever 54, an operating force on the brake lever 54 is transmitted to the brake through the cable CB4. Accordingly, a braking force for restricting rotation of the rear wheel 3 is applied from the brake to the wheel body 32 of the rear wheel 3. As shown in FIGS. 6, 9, and 10, the cables CB3 and CB4 are routed to pass through both left and right sides of the battery 74 in the space 11c inside the main frame 11. The cables CB3 and CB4 extending toward the brake and the motor 72 extend rearward from the main frame 11 through holes formed in the rear wall 116 of the main frame 11.

### Modifications

In the above description, the seat tube 14 is described as an example of the seat frame according to the present disclosure, but the seat frame may have any configuration as long as the seat frame can extend in the upper and lower direction and support the seat, and may be a solid columnar body in addition to a tube shape.

In the above description, the bridge tube 13 is described as an example of the bridge frame according to the present disclosure, but the bridge frame may have any configuration as long as the bridge frame can extend in the front and rear direction and connect the seat tube 14 (seat frame) and the main frame 11, and may be a solid columnar body in addition to a tube shape.

### Summary of Present Disclosure

The specific embodiments described above include disclosures having the following configurations.

According to a first aspect of the present disclosure, there is provided an electric motorcycle including: a vehicle body frame; a front wheel and a rear wheel; a handle disposed above the front wheel; a seat on which an occupant sits; a battery; and a motor electrically connected to the battery and configured to rotationally drive at least one of the front wheel and the rear wheel. The vehicle body frame includes: a hollow main frame including a handle support portion configured to support the handle, a seat support portion disposed behind the handle support portion and configured to support the seat, and a space extending rearward while being inclined downward from the handle support portion to the seat support portion and configured to accommodate the battery; a seat frame extending in an upper and lower direction, configured to support the seat at an upper portion, and connected to the seat support portion of the main frame at a lower portion; and a bridge frame extending in a front and rear direction, having a rear portion connected to the seat frame and a front portion connected to a portion of the main frame that is located behind the handle support portion.

According to the first aspect, since the vehicle body frame includes the bridge frame, bending rigidity of the seat frame can be improved. Specifically, the lower portion of the seat frame that supports the seat is connected to the seat support portion at a rear portion of the main frame and extends in the upper and lower direction, and is connected to the main frame via the bridge frame extending in the front and rear direction. In this structure, the main frame, the seat frame, and the bridge frame are connected to one another, thereby forming a triangle as viewed from a left and right direction of the electric motorcycle and constituting a so-called truss structure. In this structure, the seat frame is reinforced by a top frame, and bending rigidity of the electric motorcycle in the front and rear direction can be particularly improved.

In this configuration, since the bridge frame is connected to the portion of the main frame that is located behind the handle support portion, it is easy to prevent the bridge frame from becoming elongated and reduce a weight thereof. The bridge frame can reinforce the main frame by being connected to the main frame that accommodates the battery. Accordingly, deformation of the space in which the battery is accommodated can be prevented even when the electric motorcycle falls over or collides. As a result, damage to the battery and deterioration in workability of attaching and detaching the battery can be prevented.

According to a second aspect of the present disclosure, in the electric motorcycle according to the first aspect, the seat includes a seat post extending in the upper and lower direction, and a saddle fixed to an upper end portion of the seat post to support buttocks of the occupant. The seat post forms an overlapping portion of the seat post and the seat frame by inserting at least a lower end portion into the seat frame. The bridge frame is connected to the seat frame in a range of the overlapping portion.

According to the second aspect, since the bridge frame is connected to the seat frame in the range of the overlapping portion, a load from the seat post can be easily transmitted to the bridge frame, and deformation of the seat frame can be prevented.

According to a third aspect of the present disclosure, in the electric motorcycle according to the first or second aspect, the vehicle body frame further includes a rear wheel support portion configured to rotatably support the rear wheel, and a seat stay extending in the front and rear direction and having a rear portion connected to the rear wheel support portion and a front portion connected to the seat frame. The seat stay is connected to the seat frame in the range of the overlapping portion.

According to the third aspect, since the seat stay is connected to the seat frame in the range of the overlapping portion, the load from the seat post can be easily transmitted to both the bridge frame and the seat frame, and the deformation of the seat frame can be further prevented.

According to a fourth aspect of the present disclosure, in the electric motorcycle according to the first to third aspects, a connection position between the bridge frame and the seat frame is located above a connection position between the seat stay and the seat frame.

According to the fourth aspect, the seat frame is connected to the bridge frame at a portion close to an upper end portion of the seat frame. As compared with a case where the bridge frame is connected at a portion away from the upper end portion of the seat frame, the upper end portion of the seat frame can be easily prevented from being deformed forward.

According to a fifth aspect of the present disclosure, in the electric motorcycle according to the first to fourth aspects, the seat frame communicates with the space through an opening formed in an upper surface of the main frame.

According to the fifth aspect, the seat post can descend through the seat tube to a position where the lower end portion of the seat post is inserted into the space of the main frame, and thus a large amount of movement of the seat post in the upper-lower direction can be ensured.

According to a sixth aspect of the present disclosure, in the electric motorcycle according to the first to fifth aspects, a gravity center position of the battery is located in the main frame below a connection portion with the bridge frame.

According to the sixth aspect, the battery, which is a heavy object among components constituting the electric motorcycle, is disposed at a low position within the main frame, thereby improving traveling stability of the electric motorcycle.

According to a seventh aspect of the present disclosure, the electric motorcycle according to the first to sixth aspects further includes: a pair of steps fixed to the main frame, extending in a left and right direction, and each having a placing surface on which a foot of the occupant is to be placed.

According to the seventh aspect, a comfortable driving posture can be maintained by placing feet of the occupant on the placing surfaces of the steps during traveling.

According to an eighth aspect of the present disclosure, in the electric motorcycle according to the first to seventh aspects, a front end portion of the bridge frame is connected to the upper surface of the main frame. The space of the main frame is formed to extend in the upper and lower direction with respect to the connection portion with the bridge frame.

According to the eighth aspect, the front end portion of the bridge frame is connected to the upper surface of the main frame and thus does not enter the space of the main frame. Therefore, interference between the space of the main frame and the bridge frame can be prevented, and the space can be made larger. As a result, a large battery can be used.

What is claimed is:

1. An electric motorcycle comprising:
a vehicle body frame;
a front wheel and a rear wheel;
a handle disposed above the front wheel;
a seat on which an occupant sits;
a battery; and
a motor electrically connected to the battery and configured to rotationally drive at least one of the front wheel and the rear wheel, wherein
the vehicle body frame includes:
a hollow main frame including a handle support portion configured to support the handle, a seat support portion disposed behind the handle support portion and configured to support the seat, and a space extending rearward while being inclined downward from the handle support portion to the seat support portion and configured to accommodate the battery;
a seat frame extending in an upper and lower direction, configured to support the seat at an upper portion, and connected to the seat support portion of the main frame at a lower portion; and
a bridge frame extending in a front and rear direction, having a rear portion connected to the seat frame and a front portion connected to a portion of the main frame that is located behind the handle support portion.

2. The electric motorcycle according to claim 1, wherein
the seat includes a seat post extending in the upper and lower direction, and a saddle fixed to an upper end portion of the seat post to support buttocks of the occupant,
the seat post forms an overlapping portion of the seat post and the seat frame by inserting at least a lower end portion into the seat frame, and
the bridge frame is connected to the seat frame in a range of the overlapping portion.

3. The electric motorcycle according to claim 2, wherein
the vehicle body frame further includes:
a rear wheel support portion configured to rotatably support the rear wheel; and
a seat stay extending in the front and rear direction and having a rear portion connected to the rear wheel support portion and a front portion connected to the seat frame, and
the seat stay is connected to the seat frame in the range of the overlapping portion.

4. The electric motorcycle according to claim 3, wherein
a connection position between the bridge frame and the seat frame is located above a connection position between the seat stay and the seat frame.

5. The electric motorcycle according to claim 2, wherein
the seat frame communicates with the space through an opening formed in an upper surface of the main frame.

6. The electric motorcycle according to claim 1, wherein
a gravity center position of the battery is located in the main frame below a connection portion with the bridge frame.

7. The electric motorcycle according to claim 1, further comprising:
a pair of steps fixed to the main frame, extending in a left and right direction, and each having a placing surface on which a foot of the occupant is to be placed.

8. The electric motorcycle according to claim 1, wherein
a front end portion of the bridge frame is connected to the upper surface of the main frame, and
the space of the main frame is formed to extend in the upper and lower direction with respect to the connection portion with the bridge frame.
